(19) United States
(12) Patent Application Publication
(10) Pub. No.: US 2026/0321256 A1
(43) Pub. Date: Oct. 15, 2026

(54) INFORMATION PROCESSING DEVICE

(71) Applicant: TOYOTA JIDOSHA KABUSHIKI KAISHA, Toyota-shi (JP)

(72) Inventors: Takayuki YAMABE, Tokyo (JP); Aya YAMADA KAMISAKA, Tokyo (JP); Hajime TOJIKI, Tokyo (JP); Ryota NAKANISHI, Tokyo (JP); Kota HOSHIBA, Tokyo (JP)

(73) Assignee: TOYOTA JIDOSHA KABUSHIKI KAISHA, Toyota-shi (JP)

(21) Appl. No.: 19/536,497

(22) Filed: Feb. 11, 2026

(30) Foreign Application Priority Data
Apr. 10, 2025 (JP) 2025-065183

(51) Int. Cl. G10L 15/22

(52) U.S. Cl. CPC G10L 15/22; G10L 2015/223

(57) ABSTRACT

An information processing device configured to execute an AI agent that is a virtual agent configured to carry out dialogue with a user in natural language includes a control unit configured to: when a first user among a plurality of the users moves, while a first AI agent corresponding to the first user is being executed, a predetermined distance or more away from a device that provides an interface between the first AI agent and the first user, switch the first AI agent being executed to a second AI agent corresponding to a second user different from the first user among the users; and transfer, to the second AI agent, dialogue information related to dialogue with the first user and having been accumulated in the first AI agent from when the first AI agent started being executed until the first AI agent is switched to the second AI agent.

### CROSS-REFERENCE TO RELATED APPLICATION

This application claims priority to Japanese Patent Application No. 2025-065183 filed on Apr. 10, 2025. The disclosure of the above-identified application, including the specification, drawings, and claims, is incorporated by reference herein in its entirety.

### BACKGROUND

### 1. Technical Field

The present disclosure relates to information processing devices and the like that provide information via dialogue with a user.

### 2. Description of Related Art

There are techniques for carrying out dialogue with a user using natural language processing and providing information to the user based on the dialogue. In this regard, for example, Japanese Unexamined Patent Application Publication (Translation of PCT Application) No. 2021-533400 (JP 2021-533400 A) discloses a method for gradually adjusting how an automated assistant responds to a given utterance, which has been acknowledged by two or more assistant devices, such that its responses better match each user's conversational preferences over time.

### SUMMARY

An object of the present disclosure is to appropriately manage information in dialogue with a user that is carried out using machine learning.

One aspect of the present disclosure is an information processing device is an information processing device configured to execute an AI agent that is a virtual agent configured to carry out dialogue with a user in natural language. The information processing device includes a control unit configured to: when a first user among a plurality of the users moves, while a first AI agent corresponding to the first user is being executed, a predetermined distance or more away from a device that provides an interface between the first AI agent and the first user, switch the first AI agent being executed to a second AI agent corresponding to a second user different from the first user among the users; and transfer dialogue information to the second AI agent. The dialogue information is information that relates to dialogue with the first user and that has been accumulated in the first AI agent from when the first AI agent started being executed until the first AI agent is switched to the second AI agent.

Other aspects include an information processing method executed by the above information processing device, a program that causes a computer to execute the information processing method, and a computer-readable storage medium storing the program in a non-transitory manner.

The information processing device according to the present disclosure can appropriately manage information in dialogue with a user that is carried out using machine learning.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a network configuration including a server device according to a first embodiment;

FIG. 2 is a diagram illustrating components of the server device according to the first embodiment;

FIG. 3 is a flowchart of processing performed by the server device according to the first embodiment;

FIG. 4 is a flowchart illustrating processing performed by the server device to replace a word(s) according to a modification of the first embodiment; and

FIG. 5 is a flowchart of processing performed by a server device according to a second embodiment.

### DETAILED DESCRIPTION OF EMBODIMENTS

### Overview

There is a demand for services that provide appropriate information to users based on natural-language dialogue with the users.

In this regard, there are techniques in which an assistant device reflects information accumulated through dialogue with a user and provides responses that are adapted to each user's preferences.

For example, a conventional assistant device provides a response that reflects the preferences of each user in accordance with a context that includes the user's location, the time, the user who made the utterance, the placement of the assistant device, and/or the state of each device.

More specifically, a conventional assistant device acquires, together with a user's request, context data representing the user's situation at the time of the request and the user's intent in making the request. The assistant device then causes a client device to execute an action corresponding to the request in accordance with the context data. For example, consider a case in which the user previously uttered "Assistant, stop" while the assistant device was sounding an alarm, a television was playing a video, and a vehicle was being charged. If stopping actions other than sounding the alarm was incorrect in responding to the utterance "Assistant, stop," the user may then make an additional corrective utterance such as "No, stop the alarm." In such a case, the automated assistant can reflect the user's correction and/or preferences in subsequent responses.

However, conventional assistant devices still have room for improvement. For example, when accounts for multiple users are registered on a single assistant device, each user carries out dialogue with the assistant device using the account associated with that user. In such dialogue, the assistant device learns from dialogue with the user and refines its responses as described above, but dialogue used for learning is basically not shared across different accounts. However, there may be cases where multiple users make utterances involving the same topic to the assistant device. In such cases, reflecting in the dialogue with the current user what the assistant device has learned from dialogue with other users on that topic can make the interaction proceed more smoothly. It therefore is desirable for the dialog device to transfer, across multiple accounts, information obtained from dialogue with users under each account.

An information processing device according to one aspect of the present disclosure is an information processing device configured to execute an AI agent that is a virtual agent configured to carry out dialogue with a user in natural language. The information processing device includes a control unit configured to: when a first user among a plurality of the users moves, while a first AI agent corresponding to the first user is being executed, a predetermined distance or more away from a device that provides an interface between the first AI agent and the first user, switch the first AI agent being executed to a second AI agent corresponding to a second user different from the first user among the users; and transfer dialogue information to the second AI agent. The dialogue information is information that relates to dialogue with the first user and that has been accumulated in the first AI agent from when the first AI agent started being executed until the first AI agent is switched to the second AI agent.

The first user is a predetermined user who has an account for using the AI agent.

The first AI agent is an AI agent corresponding to the account of the first user. Here, an AI agent refers to a virtual agent that receives utterances or inputs from a user and carries out dialogue with the user through natural language processing. The virtual agent is implemented by a software program that provides a dialogue function with the user using natural language processing. The first AI agent can learn from dialogue with the first user.

The second user is a user different from the first user and has an account for using the AI agent.

The second AI agent is an AI agent corresponding to the account of the second user. The second AI agent can learn from dialogue with the second user.

Dialogue information refers to information accumulated by an AI agent through dialogue with a user. The dialogue information may be information obtained by analyzing the content of the user's utterances or inputs to the AI agent and accumulating the results. The dialogue information may also be data calculated as feature values by analyzing the utterances or inputs.

When the first user moves the predetermined distance or more away from the device that provides an interface between the first AI agent and the first user, the control unit switches the AI agent being executed from the first AI agent corresponding to the first user to the second AI agent corresponding to the second user, and transfers to the second AI agent the dialogue information accumulated in the first AI agent.

In this manner, the information processing device according to the present disclosure can share dialogue histories of individual accounts across multiple accounts during dialogue with users using natural language processing.

With this configuration, the information processing device according to the present disclosure can appropriately manage information in dialogue with users carried out using machine learning.

The information processing device according to the present disclosure may further include a storage unit that stores a database including information indicating relationships among the users. The control unit may be configured to switch the first AI agent to the second AI agent corresponding to the second user selected from among the users based on relationship information that is the information indicating the relationships among the users and included in the database.

For example, consider a situation in which multiple users are riding in a vehicle capable of carrying out dialogue with an AI agent. It is herein assumed that the vehicle is occupied by a driver, the driver's family, and a guest. In such a case, the AI agent corresponding to the driver is basically executed. However, for example, when the driver leaves the vehicle, the AI agent may be temporarily switched to another user's AI agent. If this AI agent corresponds to a user who is not closely related to the driver, such as the guest, there is a risk that information that the user of this AI agent (the guest) does not want other occupants to know may be revealed through dialogue with this AI agent. This is inappropriate from a privacy perspective. Accordingly, the information processing device according to the present disclosure switches to an AI agent corresponding to a user who is in an appropriate relationship with the user of the AI agent being executed (typically the driver), such as this user's family. The information processing device according to the present disclosure can thus switch to an appropriate AI agent by taking into account the relationships among users.

The control unit may be configured to transfer, to the second AI agent, information selected from the dialogue information based on a relationship between the first user and the second user as indicated by the relationship information.

For example, if all dialogue information accumulated in the AI agent being executed is transferred to the AI agent to be switched to, information that the user of the AI agent being executed prefers not to disclose to the user of the AI agent to be switched to may be revealed to the user of the AI agent to be switched to through dialogue. Therefore, the information processing device according to the present disclosure selects the information to be transferred based on the relationship between the user of the AI agent being executed and the user of the AI agent to be switched to. The information processing device according to the present disclosure can thus transfer appropriate information based on the relationship between the user of the AI agent being executed and the user corresponding to the AI agent to be switched to.

The control unit may be configured to determine a relationship between the first user and the second user by analyzing a conversation conducted within a predetermined range of the device that provides the interface between the first AI agent and the first user while the first AI agent is being executed, and transfer the dialogue information to the second AI agent when the second user is determined to be in a specific relationship with the first user.

Depending on, for example, the relationship between the user of the AI agent being executed and the user of the AI agent to be switched to, it may be inappropriate to transfer the accumulated information. For example, it may be appropriate to transfer the information to the AI agent corresponding to the driver's wife, but it may be inappropriate from a privacy perspective to transfer the information to the AI agent corresponding to a guest who is temporarily riding in the vehicle. Therefore, the information processing device according to the present disclosure transfers the accumulated information to AI agents corresponding to users who are in a specific relationship with the user of the AI agent being executed. The information processing device according to the present disclosure can thus transfer information to AI agents corresponding to users who are in an appropriate relationship with the user of the AI agent being executed.

The control unit may further be configured to transfer to the second AI agent the dialogue information in which one or more first words included in the dialogue information and having a predetermined property are replaced with one or more second words that differ from the one or more first words but have a same part of speech as the one or more first words.

The information processing device according to the present disclosure can thus conceal information having the predetermined property when transferring information to the AI agent to be switched to.

Hereinafter, embodiments of the present disclosure will be described with reference to the drawings. Unless otherwise specified, the hardware configurations, module configurations, functional configurations, etc. described in the embodiments are not intended to limit the technical scope of the present disclosure to those configurations.

### First Embodiment

### Overview of Processing Performed by Server Device

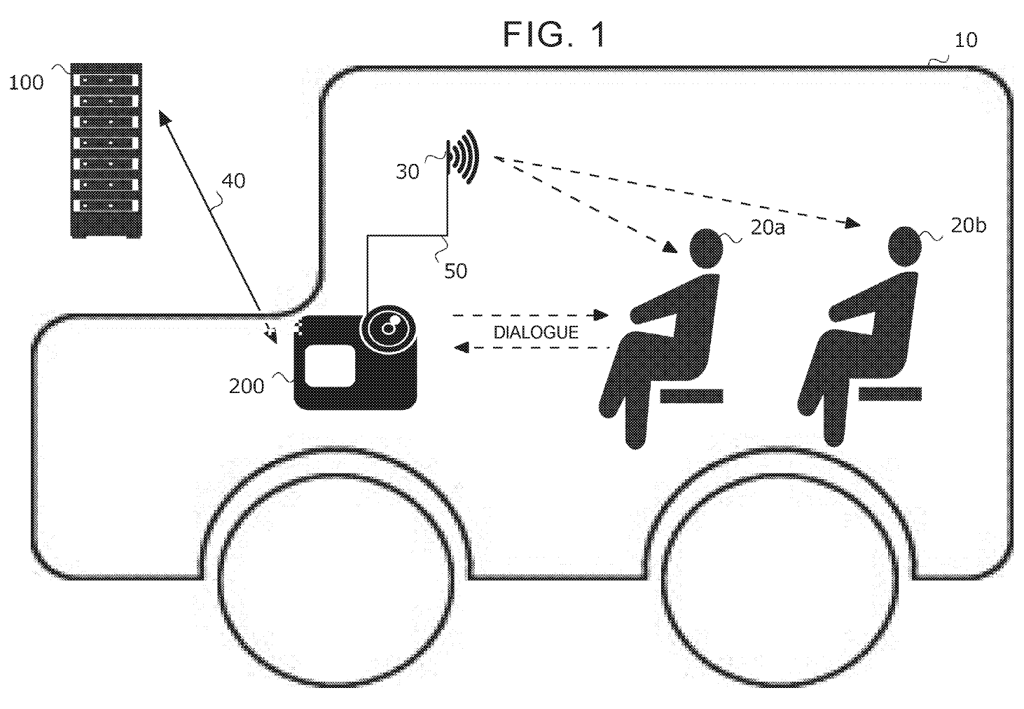

An overview of a network configuration including a server device according to a first embodiment will be described with reference to FIG. 1. FIG. 1 shows a network configuration including a server device 100 according to the embodiment. An information processing device according to one aspect of the present disclosure is implemented as the server device 100.

The server device 100 is an information processing device that provides appropriate information to a user 20 based on dialogue with the user 20 carried out using natural language processing that uses generative artificial intelligence (AI) etc. The server device 100 communicates with an in-vehicle terminal 200 via a communication network 40 via a wide area network. Hereinafter, users 20a, 20b are collectively referred to as "user 20."

Typically, the user 20 is riding in a vehicle 10 and speaks to the in-vehicle terminal 200 that communicates with the server device 100. The server device 100 analyzes the utterance of the user 20 etc. acquired via the in-vehicle terminal 200 and generates a response corresponding to the meaning of the utterance. This processing is performed by an AI agent corresponding to the user 20 and being executed by the server device 100. For example, the server device 100 reads the user's intent from the content of the user's utterance and generates an appropriate response. The natural language processing used to generate dialogue with the user 20 may instead be performed by the in-vehicle terminal 200. In that case, the in-vehicle terminal 200 is equipped with artificial intelligence such as generative AI.

The server device 100 acquires, from a sensor 30 installed in the vehicle 10, information for identifying the user 20. Specifically, the sensor 30 transmits acquired information to a communication unit (described below) of the vehicle 10 via an in-vehicle network 50, and the communication unit of the vehicle 10 then sends that information to the server device 100 via the communication network 40. In this manner, the information acquired by the sensor 30 for identifying the user 20 riding in the vehicle is transmitted to the server device 100.

For example, consider a case where the users 20a, 20b are riding in the vehicle. When the user 20a is the driver, the server device 100 executes an AI agent corresponding to the account of the user 20a and provides it to the vehicle 10. When it is determined based on the information acquired by the sensor 30 that the user 20a has exited the vehicle 10, the server device 100 may switch the AI agent being executed to the AI agent corresponding to the account of another occupant, namely the user 20b.

### Configuration of Server Device

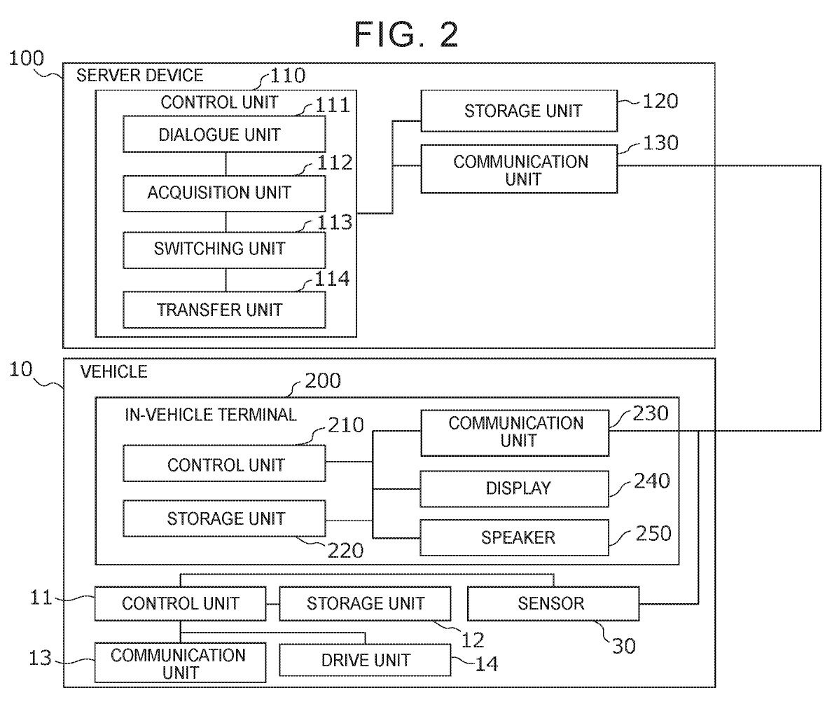

Next, the hardware and software configurations of the system including the server device 100 will be described. FIG. 2 illustrates components of in the server device 100 according to the first embodiment.

The server device 100 can be configured as a computer that includes a processor (a central processing unit (CPU), a graphics processing unit (GPU), etc.), a main storage device (random access memory (RAM), read-only memory (ROM), etc.), and an auxiliary storage device (erasable programmable read-only memory (EPROM), hard disk drive, removable medium, etc.). The auxiliary storage device stores an operating system (OS), various programs, various tables, etc. Various functions (software modules) for predetermined purposes, as described later, can be implemented by executing the programs stored in the auxiliary storage device. However, part or all of the functions may alternatively be implemented as hardware modules by using hardware circuits such as application-specific integrated circuits (ASICs) or field-programmable gate arrays (FPGAs).

The server device 100 includes a control unit 110, a storage unit 120, and a communication unit 130.

The control unit 110 is a processing unit that implements various functions of the server device 100 by executing predetermined programs. The control unit 110 can be implemented by a hardware processor such as a CPU. The control unit 110 may include RAM, ROM, and cache memory.

In the present embodiment, the control unit 110 of the server device 100 includes four software modules: a dialogue unit 111, an acquisition unit 112, a switching unit 113, and a transfer unit 114. Each software module may be implemented by the control unit 110 (e.g., a CPU) executing programs stored in the storage unit 120. The information processing performed by the software modules is equivalent to the information processing performed by the control unit 110 (e.g., the CPU).

The dialogue unit 111 is a processing unit that carries out dialogue with the user 20 in natural language. The dialogue unit 111 executes an AI agent corresponding to the user 20, analyzes voice of the user 20 recognized by a microphone or text input by the user 20, and generates a response corresponding to the meaning of the voice or text. The dialogue unit 111 can acquire information by communicating with an external network via the communication unit 130. The dialogue unit 111 outputs responses in the form of voice or text.

The acquisition unit 112 acquires data obtained by the sensor 30. The data acquired by the acquisition unit 112 may be any type of data that is used to identify the user 20 riding in the vehicle or to estimate relationships among the users 20 riding in the vehicle. The acquisition unit 112 acquires audio captured by the sensor 30. The sensor 30 may be a camera, and the acquisition unit 112 may acquire images captured by the camera. The sensor 30 may be a sensor capable of detecting movements of the user 20, such as a distance sensor, and the acquisition unit 112 may acquire results indicating the detection of the user 20 getting into the vehicle. The sensor 30 may detect other movements of the user 20. The sensor 30 may also be a device that detects location information of the user 20, and the acquisition unit 112 may acquire the location information of the user 20. The location information of the user 20 may be location information obtained by a Global Navigation Satellite System (GNSS) for a terminal associated with the user 20.

The acquisition unit 112 also acquires, from an external device, information indicating relationships among users.

The switching unit 113 performs switching of the AI agent being executed. When, while the AI agent corresponding to the user 20a (herein referred to as the first AI agent) is being executed, the user 20a moves a predetermined distance or more away from the device that provides the interface between the user 20a and the first AI agent (i.e., the in-vehicle terminal 200), the switching unit 113 performs the following processing. The switching unit 113 switches the currently executing first AI agent to an AI agent corresponding to the user 20b (herein referred to as the second AI agent).

The transfer unit 114 transfers, to the second AI agent, dialogue information related to dialogue with the user 20a and having been accumulated in the first AI agent from when the first AI agent started being executed until the first AI agent is switched to the second AI agent.

The storage unit 120 serves as means for storing information and is configured using a storage medium such as RAM, magnetic disk, or flash memory. The storage unit 120 stores programs executed by the control unit 110 and data used by those programs.

The communication unit 130 is a wireless communication interface that connects the server device 100 to an external network. The communication unit 130 is configured to communicate with external devices via, for example, a wireless local area network (LAN) or a third-generation (3G), fourth-generation (4G), or fifth-generation (5G) cellular network.

The vehicle 10 is a vehicle capable of communicating with the communication network 40. The vehicle 10 may be a passenger car, or may be a large vehicle such as a bus or a truck. The vehicle 10 includes a control unit 11, a storage unit 12, a communication unit 13, a drive unit 14, the sensor 30, and the in-vehicle terminal 200.

The control unit 11 is a computing unit that implements various functions of the vehicle 10 by executing predetermined programs. The control unit 11 can be implemented by, for example, a hardware processor such as a CPU. The control unit 11 may also include RAM, ROM, cache memory, etc. The control unit 11 executes various software programs for controlling driving and other functions of the vehicle 10.

The storage unit 12 serves as means for storing information, and is configured using a storage medium such as RAM, a magnetic disk, or flash memory. The storage unit 12 stores programs executed by the control unit 11 and data used by those programs.

The communication unit 13 is a wireless communication interface that connects the vehicle 10 to an external network. The communication unit 13 is configured to communicate with external devices via, for example, a wireless LAN or a 3G, 4G, or 5G cellular network.

The drive unit 14 is a mechanism that causes the vehicle 10 to travel. The drive unit 14 may include, for example, a motor and inverter for driving the wheels, brakes, and a steering mechanism. The drive unit 14 may be driven by electric power supplied from a battery.

The sensor 30 herein refers to sensors installed in the vehicle 10. The sensor 30 may include, for example, a temperature sensor, a radio-wave distance sensor, an infrared sensor, a touch sensor, and a microphone.

The in-vehicle terminal 200 is a terminal that receives operations performed by the user 20 of the vehicle 10 on various devices provided in the vehicle 10 and provides information to the user 20. The in-vehicle terminal 200 includes a control unit 210, a storage unit 220, a communication unit 230, a display 240, and a speaker 250.

The in-vehicle terminal 200 is an example of the "device that provides an interface between the first AI agent and the first user" in the present disclosure.

The control unit 210 receives input from the user 20 and transmits the input to the server device 100 via the communication unit 230. The control unit 210 outputs, via the display 240 or the speaker 250, text or audio indicating a response to the input, namely a response that has been transmitted from the server device 100.

The storage unit 220 serves as means for storing information and is configured using a storage medium such as RAM, magnetic disk, or flash memory. The storage unit 220 stores programs executed by the control unit 210 and data used by those programs.

The communication unit 230 is a wireless communication interface that connects the in-vehicle terminal 200 to the communication network 40. The communication unit 230 is configured to communicate with external devices via, for example, a wireless LAN or a 3G, 4G, or 5G cellular network.

The display 240 is a display for presenting images and other information to the user. The display 240 may be a liquid crystal display or an organic electroluminescence (EL) display. The display 240 may also be implemented as a touch panel display.

The speaker 250 is a device that outputs audio for providing information to the user. The speaker 250 includes at least a voice coil, a magnet, and a cone. The speaker 250 may be a full-range speaker. The speaker 250 may be provided in the vehicle 10 as a car speaker, instead of being provided in the in-vehicle terminal 200.

The configuration shown in FIG. 2 is merely an example, and all or part of the illustrated functions may be executed using dedicated circuits. Programs may be stored or executed using any combination of main and auxiliary storage devices other than the illustrated combination.

### Processing Performed by Server Device

Next, the specific processing performed by the server device 100 according to one embodiment of the present disclosure will be described.

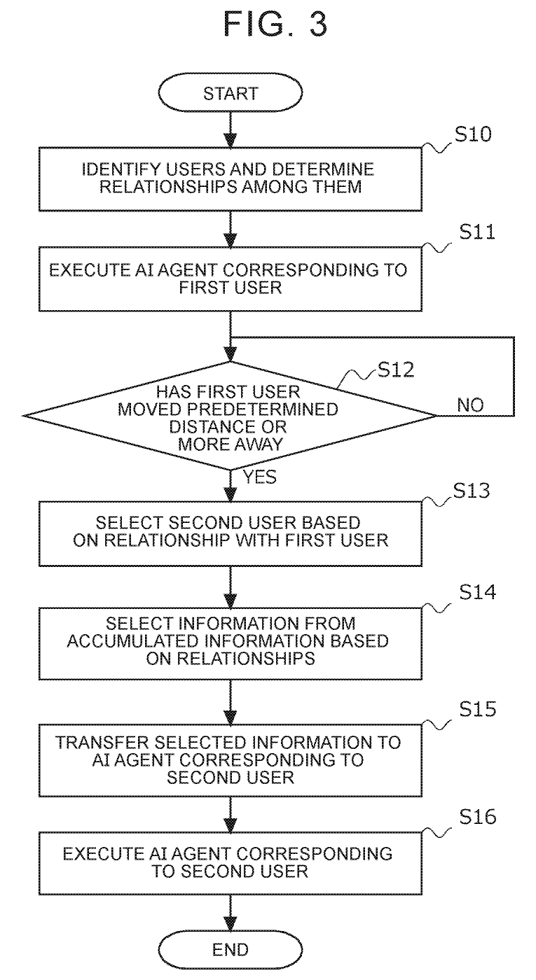

Here, processing performed by the server device 100 to switch AI agents will be described. FIG. 3 is a flowchart illustrating processing performed by the server device 100 according to the first embodiment. In the present embodiment, it is assumed that the AI agent corresponding to the driver (user 20a) is executed while the vehicle 10 is traveling. The processing illustrated in FIG. 3 is performed when the vehicle 10 starts traveling. Alternatively, the processing illustrated in FIG. 3 may be performed when an occupant gets into or out of the vehicle 10, or when a change of the account corresponding to the AI agent being executed is requested.

First, in step S10, the acquisition unit 112 identifies each of the users 20 and determines relationships among the users 20. For example, the acquisition unit 112 may acquire an image from an in-vehicle camera included in the sensor 30 and analyze the image to identify each user 20. Alternatively, the acquisition unit 112 may communicate, via the communication unit 230 of the in-vehicle terminal 200, with mobile terminals respectively associated with the users 20 to acquire information for identifying each of the users 20. The acquisition unit 112 may identify each of the users 20 based on the information acquired from the mobile terminals.

In this step, the acquisition unit 112 also acquires information indicating relationships among the users 20 (hereinafter referred to as "relationship information"). The acquisition unit 112 communicates, via the communication unit 130 and the communication network 40, with an external device, and refers to a database stored in the external device and including the relationship information. The external device may be a server device installed at a predetermined location, or may be a mobile terminal associated with one of the users 20. The acquisition unit 112 then determines relationships among the identified users 20 based on the relationship information.

Next, in step S11, the dialogue unit 111 executes the AI agent corresponding to the user 20a (the first AI agent). The user 20a is an example of the "first user." The dialogue unit 111 carries out dialogue with the user 20a and other occupants by the first AI agent. Specifically, the dialogue unit 111 analyzes, through natural language processing, utterances made by the user 20a or other occupants of the vehicle 10, or input made to the in-vehicle terminal 200, and outputs responses generated by the generative AI via the speaker 250 or the display 240.

Next, in step S12, the switching unit 113 determines whether the user 20a has moved a predetermined distance or more away from the in-vehicle terminal 200. The switching unit 113 determines whether the user 20a has moved the predetermined distance or more away from the in-vehicle terminal 200 based on data acquired from the sensor 30 by the acquisition unit 112.

The switching unit 113 may also identify the ID of a mobile terminal associated with the user 20a that is present inside the vehicle 10. The switching unit 113 may determine that the user 20a has moved the predetermined distance or more away from the in-vehicle terminal 200 when the signal strength, inside the vehicle 10, of the mobile terminal with the ID acquired by the acquisition unit 112 is less than or equal to a predetermined value. The switching unit 113 may also analyze an image from an in-vehicle camera of the vehicle 10 acquired by the acquisition unit 112 to identify the image of the user 20a. The switching unit 113 may determine whether the user 20a is present inside the vehicle, and may determine that the user 20a has moved the predetermined distance or more away from the in-vehicle terminal 200 when it is determined that the user 20a is not present inside the vehicle.

In this step, the switching unit 113 makes an affirmative determination when it determines that the user 20a has moved the predetermined distance or more away from the in-vehicle terminal 200.

When an affirmative determination is made in step S12, the processing proceeds to step S13.

When a negative determination is made in step S12, the processing returns to step S12.

When the processing proceeds to step S13, the switching unit 113 selects the user 20b based on the relationship information acquired in step S10 and preset selection criteria. The user 20b is an example of the "second user." The switching unit 113 selects, based on the relationship with the first user and the preset selection criteria, the user (the user 20b in the present embodiment) as the second user. The selection criteria may specify an order of priority among relationships between the user 20a that is the first user and potential second users. For example, the selection criteria may specify that "the second user is selected in the order of wife, child, and friend."

For example, the switching unit 113 may select, as the second user, a user having the relationship of "wife" to the user 20a. The switching unit 113 may select, as the second user, a user having the relationship of "family" to the user 20a. The switching unit 113 may also select, as the second user, a user designated in advance by the user 20a as the switching destination.

Next, in step S14, the transfer unit 114 selects, based on the relationship information, information to be transferred to the AI agent corresponding to the second user (the second AI agent) from among the information accumulated during dialogue carried out by the dialogue unit 111 using the first AI agent. For example, the transfer unit 114 may select, based on the relationship between the user 20b and the user 20a, information not related to the privacy of the user 20a or information for which the need for concealment is low. Specifically, when the user 20b is the wife of the user 20a, the transfer unit 114 does not select business-related information, but selects family-related or leisure-related information.

Next, in step S15, the transfer unit 114 transfers the information selected in step S14 to the second AI agent. The transfer unit 114 provides, as learning data for the generative AI used by the second AI agent in dialogue, information that has been accumulated in the generative AI used by the first AI agent. The accumulated information may be data representing utterances or inputs themselves made by the user 20a etc., or data output from an intermediate layer of the generative AI used by the first AI agent.

Next, in step S16, the dialogue unit 111 executes the second AI agent. The dialogue unit 111 carries out dialogue with the user 20b and other occupants through the second AI agent.

As described above, in the present embodiment, when the server device 100 of the present embodiment switches from the AI agent corresponding to the user 20a to the AI agent corresponding to the user 20b, the server device 100 appropriately transfers information. The server device 100 can thus appropriately manage information in dialogue with users carried out using machine learning.

### Modifications of First Embodiment

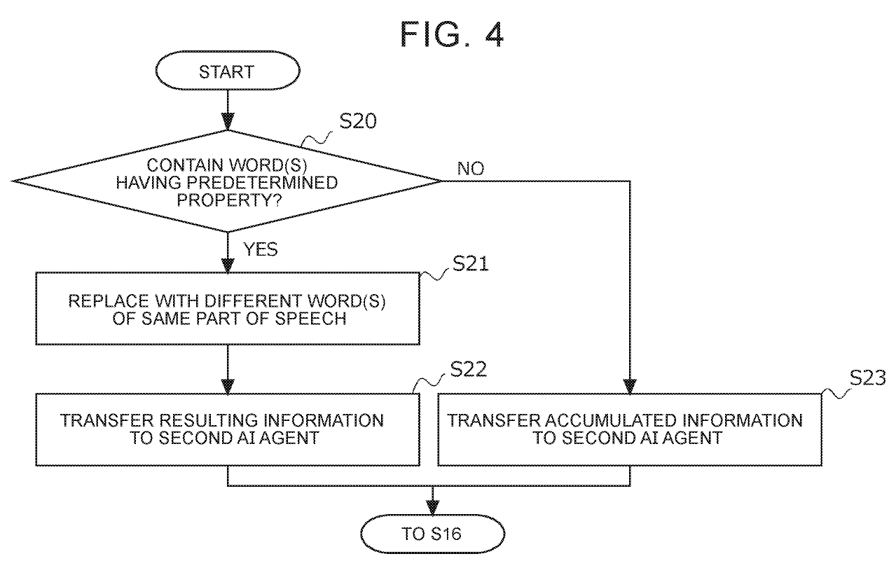

In the first embodiment, the server device 100 transfers the selected information without processing it. However, even information determined to be non-transferable can sometimes become transferable through processing of part of the information. Accordingly, in this modification, in order to broaden the range of information that can be transferred, part of information that would otherwise be non-transferable is processed. FIG. 4 is a flowchart illustrating processing performed by the server device 100 to replace a word(s) according to the modification of the first embodiment. The processing illustrated in FIG. 4 is a concrete implementation of the processing in step S15 of FIG. 3.

First, in step S20, the transfer unit 114 determines whether the dialogue information contains one or more words having a predetermined property (herein referred to as "first words"). For example, a word having the predetermined property is a word that represents an expression related to privacy. For example, words having the predetermined property may include personal information, such as a person's name, date of birth, social security number, movement history, or previously visited locations.

The transfer unit 114 may analyze the content of the dialogue with the user 20a, acquired by the dialogue unit 111, using natural language processing etc., and determine whether the first word(s) is contained in the dialogue. In this step, an affirmative determination is made when the transfer unit 114 determines that the dialogue information contains the first word(s).

When an affirmative determination is made in this step, the processing proceeds to step S21.

When a negative determination is made in this step, the processing proceeds to step S23.

When the processing proceeds to step S21, the transfer unit 114 replaces the first word(s) in the dialogue information with a second word(s) that is of the same part of speech as the first word(s) but is different from the first word(s). For example, the transfer unit 114 may replace a word indicating specific personal information with another word of the same part of speech that does not specify such specific personal information. More specifically, the transfer unit 114 may replace a specific store name previously visited by the user 20a, such as "○○ Store," with another word of the same part of speech (in this case, noun) that does not indicate a specific store name, such as "grocery store."

Next, in step S22, the transfer unit 114 transfers to the second AI agent the dialogue information in which the first word(s) has been replaced with the second word(s) in step S21. The information to be transferred may be data that represents the utterance or input itself made by the user 20a etc. and in which the first word(s) has been replaced with the second word(s). Alternatively, the information to be transferred may be data output by the generative AI used by the first AI agent, after data that represents the utterance or input itself made by the user 20a etc. and in which the first word(s) has been replaced with the second word(s) is input to that generative AI. The information to be transferred may be data output from an intermediate layer of the generative AI.

### Second Embodiment

In the first embodiment, the server device 100 selects the second AI agent to be switched to, based on relationship information acquired from an external device. However, the server device 100 may independently determine the relationship between the user corresponding to the AI agent to be switched to and the user corresponding to the AI agent currently being executed, and select the AI agent to be switched to. Accordingly, in the second embodiment, the server device 100 determines the relationship between the user corresponding to the AI agent to be switched to and the user corresponding to the AI agent currently being executed.

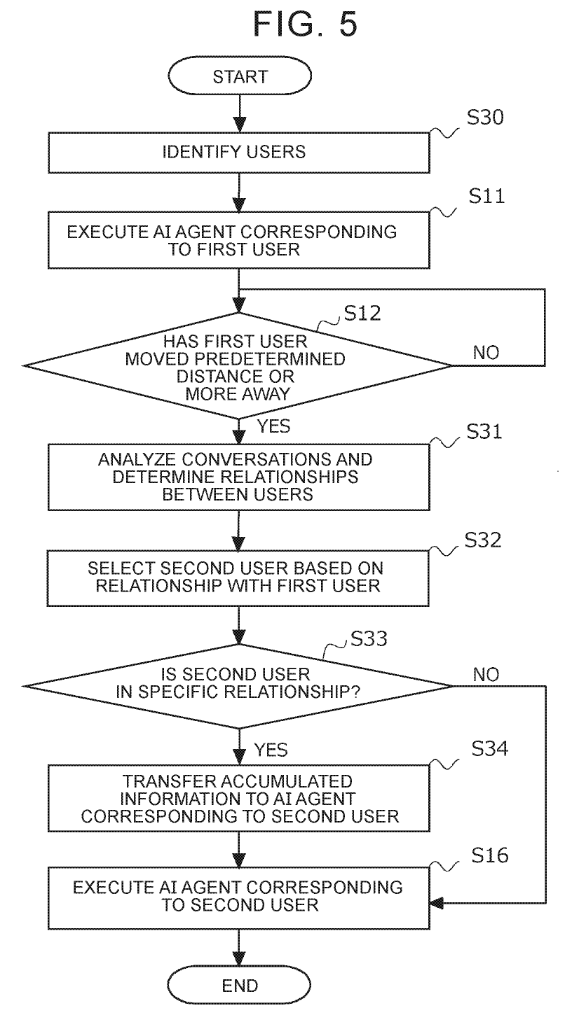

FIG. 5 is a flowchart of the processing performed by the server device 100 according to the second embodiment. In FIG. 5, the same steps as those described with respect to FIG. 3 are denoted by the same reference signs as those in FIG. 3. The following description regarding FIG. 5 focuses on the steps different from those in FIG. 3.

In step S30, the acquisition unit 112 identifies each of the users 20. The acquisition unit 112 may acquire an image captured by the in-vehicle camera included in the sensor 30 and identify each of the users 20 by analyzing the image. Alternatively, the acquisition unit 112 may communicate, via the communication unit 230 of the in-vehicle terminal 200, with mobile terminals respectively associated with the users 20 to acquire information for identifying each of the users 20. The acquisition unit 112 may identify each of the users 20 based on the information acquired from the mobile terminals.

After step S12, in step S31, the switching unit 113 analyzes conversations among users who are within a predetermined range of the in-vehicle terminal 200, and determines the relationships between the user 20a and the other users. For example, in a case where certain words indicating a specific relationship are included in the conversation between the user 20a and another user, the switching unit 113 may determine that these two users have that relationship. Examples of such specific relationships may include a married couple and a family.

For example, when the first names of the user 20a and another user appear as terms of address in their conversation, the switching unit 113 may determine that they are a married couple or partners. When terms indicating family roles such as "father" or "mother" appear as terms of address in the conversation between the user 20a and another user, the switching unit 113 may determine that they are family members.

Next, in step S32, the switching unit 113 selects the user 20b (the second user) based on the relationships between the user 20a and the other users, as determined in step S31. For example, the switching unit 113 may select, as the second user, a user who is a family member of the user 20a. The switching unit 113 may alternatively select, as the second user, the user whose relationship with the user 20a is considered to be the closest among the other users. For example, when none of the other users is a family member of the user 20a, a friend of the user 20a may be selected as the second user.

Next, in step S33, the switching unit 113 determines whether the user 20b selected in step S32 is in a specific relationship with the user 20a. For example, although the switching unit 113 may have selected a family member of the user 20a as the user 20b in step S32, the switching unit 113 may further determine whether the selected user 20b is the wife of the user 20a. Examples of such specific relationships may include husband, wife, mother, and father. The switching unit 113 may alternatively determine whether the user 20b selected in step S32 is in a predetermined relationship.

In this step, the switching unit 113 makes an affirmative determination when it determines that the user 20b is in a specific relationship with the user 20a.

When an affirmative determination is made in this step, the processing proceeds to step S34.

When a negative determination is made in this step, the processing proceeds to step S16.

When the processing proceeds to step S34, the transfer unit 114 transfers, to the AI agent corresponding to the user 20b (the second agent), the information accumulated during dialogue carried out by the dialogue unit 111 using the first AI agent.

As described above, in the present embodiment, the server device 100 determines the relationships among users by analyzing conversations among them, and thus determine the AI agent to be switched to. At this time, the server device 100 transfers information appropriately based on the determined relationship. The server device 100 can thus appropriately manage information in dialogue with users using machine learning, even when there is a user who has not been previously recognized.

### Other Modifications

The above embodiments are merely examples, and the present disclosure may be modified as appropriate without departing from the spirit and scope of the disclosure. For example, the processes and means described in the present disclosure can be combined as desired as long as no technical contradiction occurs.

The above embodiments illustrate an example in which the information processing device of the present disclosure is the server device 100. However, the processing performed by the information processing device of the present disclosure in the first embodiment, the modifications of the first embodiment, and the second embodiment may alternatively be performed by the in-vehicle terminal 200. In such a case, the in-vehicle terminal 200 performs the acquisition of relationship information or the determination of relationships among users, the execution of the first AI agent, the selection of the second AI agent, and the switching to the second AI agent. The in-vehicle terminal 200 also performs the selection of the information to be transferred to the second AI agent and the transfer of the selected information.

In a case where the processing in the first embodiment, the modifications of the first embodiment, and the second embodiment is performed by the in-vehicle terminal 200, the in-vehicle terminal 200 acquires relationship information from an external device through communication via the communication network 40.

The in-vehicle terminal 200 then identifies the user 20a based on data acquired from the sensor 30 etc. and executes the first AI agent corresponding to the user 20a. In addition, when the in-vehicle terminal 200 determines that the user 20a has moved a predetermined distance or more away from the in-vehicle terminal 200, the in-vehicle terminal 200 performs the following operations. The in-vehicle terminal 200 selects, based on the relationship information, the second AI agent to be switched to in place of the first AI agent. The in-vehicle terminal 200 then transfers to the second AI agent the information selected based on the relationship information.

Part of the processing performed by the in-vehicle terminal 200, such as dialogue generation using a generative AI, may be performed by the server device 100, and the remaining processing described above may be performed by the in-vehicle terminal 200.

In the first embodiment, the transfer unit 114 performs the processing of step S14. However, the transfer unit 114 may omit the processing of step S14 and transfer all accumulated information to the second AI agent instead. Alternatively, the transfer unit 114 may transfer the accumulated information to the second AI agent when the user 20b is in a specific relationship with the user 20a. In such a case, the information that is transferred may be all of the accumulated information or the information selected in the same manner as in step S14.

In the second embodiment, the transfer unit 114 transfers all accumulated information to the second AI agent when the user 20b was in a specific relationship with the user 20a. However, the transfer unit 114 may alternatively select and transfer part of the accumulated information based on the relationship between the user 20a and the user 20b.

The present disclosure may also be implemented by supplying a computer with a computer program that implements the functions described in the above embodiments, and causing one or more processors included in the computer to read and execute the program. Such a computer program may be provided to the computer via a non-transitory computer-readable storage medium connectable to the system bus of the computer, or may be provided to the computer via a network. Examples of the non-transitory computer-readable storage medium may include any type of disk such as a magnetic disk (floppy (registered trademark) disk, hard disk drive (HDD), etc.), an optical disc (compact disc read-only memory (CD-ROM), digital versatile disc (DVD), Blu-ray disc, etc.), read-only memory (ROM), random access memory (RAM), erasable programmable read-only memory (EPROM), electrically erasable programmable read-only memory (EEPROM), a magnetic card, flash memory, an optical card, and any other type of medium suitable for storing electronic instructions.

What is claimed is:

1. An information processing device configured to execute an AI agent that is a virtual agent configured to carry out dialogue with a user in natural language, the information processing device comprising a control unit configured to
when a first user among a plurality of the users moves, while a first AI agent corresponding to the first user is being executed, a predetermined distance or more away from a device that provides an interface between the first AI agent and the first user, switch the first AI agent being executed to a second AI agent corresponding to a second user different from the first user among the users, and
transfer dialogue information to the second AI agent, the dialogue information being information that relates to dialogue with the first user and that has been accumulated in the first AI agent from when the first AI agent started being executed until the first AI agent is switched to the second AI agent.

2. The information processing device according to claim 1, further comprising a storage unit that stores a database including information indicating relationships among the users,
wherein the control unit is configured to switch the first AI agent to the second AI agent corresponding to the second user selected from among the users based on relationship information that is the information indicating the relationships among the users and included in the database.

3. The information processing device according to claim 2, wherein the control unit is configured to transfer, to the second AI agent, information selected from the dialogue information based on a relationship between the first user and the second user as indicated by the relationship information.

4. The information processing device according to claim 1, wherein the control unit is configured to
determine a relationship between the first user and the second user by analyzing a conversation conducted within a predetermined range of the device that provides the interface between the first AI agent and the first user while the first AI agent is being executed, and
transfer the dialogue information to the second AI agent when the second user is determined to be in a specific relationship with the first user.

5. The information processing device according to claim 1, wherein the control unit is further configured to transfer to the second AI agent the dialogue information in which one or more first words included in the dialogue information and having a predetermined property are replaced with one or more second words that differ from the one or more first words but have a same part of speech as the one or more first words.
